(19) United States
(12) Patent Application Publication
(10) Pub. No.: US 2025/0371212 A1
(43) Pub. Date: Dec. 4, 2025

(54) TECHNIQUES FOR GENERATING OPTIMIZED MECHANICAL SYSTEMS

(71) Applicant: AUTODESK, INC., San Francisco, CA (US)

(72) Inventors: Nastaran SHAHMANSOURI, Toronto (CA); Hyunmin CHEONG, Toronto (CA); Alexander TESSIER, Toronto (CA); Adrian BUTSCHER, Toronto (CA)

(21) Appl. No.: 19/196,669

(22) Filed: May 1, 2025

Related U.S. Application Data
(60) Provisional application No. 63/655,407, filed on Jun. 3, 2024.

(51) Int. Cl. G06F 30/20; G06F 30/17; G06F 111/20

(52) U.S. Cl. CPC G06F 30/20; G06F 30/17; G06F 2111/20

(57) ABSTRACT

A computer-implemented method for generating a mechanical system, the method comprising: based on a mechanical input to the mechanical system and a target mechanical output of the mechanical system, generating a set of multiple candidate mechanical systems for generating the target mechanical output in response to receiving the mechanical input, wherein each candidate mechanical system includes multiple mechanical building blocks that form a kinematic chain; selecting a candidate mechanical system included in the set of multiple candidate mechanical systems; and generating an optimized configuration of the selected candidate mechanical system based on a set of dynamic equations for the mechanical system, wherein each dynamic equation included in the set of dynamic equations corresponds to one mechanical building block of the selected candidate mechanical system.

### CROSS-REFERENCE TO RELATED APPLICATIONS

This application claims priority benefit of the United States Provisional Patent Application titled, “MODULAR TECHNIQUES FOR GENERATING AND OPTIMIZING MECHANISMS,” filed on Jun. 3, 2024, and having Ser. No. 63/655,407. The subject matter of this related application is hereby incorporated herein by reference.

### BACKGROUND

### Field of the Various Embodiments

The various embodiments relate generally to computer science and complex software applications, and, more specifically, to techniques for generating optimized mechanical systems.

### Description of the Related Art

Mechanism design is an important technique in the field of mechanical engineering, and plays a significant role in the development and innovation of machines and mechanical systems. Generally, mechanism design involves the conceptualization, analysis, and optimization of machines and mechanical systems to achieve a desired functionality or output.

Mechanism design can be a complex and open-ended process. First, design engineers oftentimes face complex problems with conflicting goals, such as minimizing the weight while maximizing the strength or durability of a mechanical system or device. Thus, changes to a mechanical system to enhance performance with respect to one design goal can reduce the performance of that system with respect to another design goal. In addition, when mechanical inputs to a mechanical system (e.g., rotation at a specific rotational speed of a shaft)—along with a target mechanical output from the mechanical system (e.g., motion of a component along a prescribed path, an output torque, etc.)—are specified, many different combinations of mechanical devices (e.g., gears, shafts, linkages, etc.) can be linked together as a proposed mechanical system. Further, each such proposed mechanical system can be implemented in a nearly infinite number of possible configurations, given the physical attributes of each mechanical device (e.g., link length, gear-tooth radius, pulley radius, worm-gear diametral pitch, etc.) can be varied through a continuum of different values. Thus, while mechanism design can be a highly beneficial technique in mechanical system design, selection of a more effective mechanical system from the expansive set of potentially feasible mechanical systems can be problematic.

Simplifying the process of mechanism design has been extensively explored. For example, to provide a more structured approach in the conceptual phase of mechanical design, the concept of kinematic building blocks has been developed. Kinematic building blocks—also referred to as kinematic functional units—qualitatively represent the types of motion a particular mechanical device included in a mechanical system can perform, such as rotation, translation, etc. For instance, a pulley-belt mechanism can be abstractly instantiated as a kinematic building block that receives an input torque and generates an output torque, while a worm-gear mechanism can be instantiated as a kinematic building block that receives an input rotation of a worm-gear shaft and generates an output rotation of a spur gear. Thus, kinematic building blocks enable designers to assemble a group of kinematically-compatible mechanical devices into a mechanical system that generates a targeted mechanical output.

Despite the foregoing benefits, the use of kinematic building blocks cannot offer a mechanical designer any insight into how effectively a particular group of assembled mechanical devices can generate a targeted mechanical output, for example, with respect to one or more performance criteria. Instead, mechanical designers are oftentimes forced to select a final configuration of a mechanical system by trial and error, which can be time-consuming and can result in overlooking more effective configurations of that mechanical system. Furthermore, such trial-and-error approaches are generally not suitable for comparing the overall effectiveness with which different mechanical systems can generate the targeted mechanical output.

As the foregoing illustrates, what is needed in the art are more effective techniques for determining desirable configurations for mechanical systems.

### SUMMARY

A computer-implemented method for generating a mechanical system, the method comprising: based on a mechanical input to the mechanical system and a target mechanical output of the mechanical system, generating a set of multiple candidate mechanical systems for generating the target mechanical output in response to receiving the mechanical input, wherein each candidate mechanical system includes multiple mechanical building blocks that form a kinematic chain; selecting a candidate mechanical system included in the set of multiple candidate mechanical systems; and generating an optimized configuration of the selected candidate mechanical system based on a set of dynamic equations for the mechanical system, wherein each dynamic equation included in the set of dynamic equations corresponds to one mechanical building block of the selected candidate mechanical system.

At least one technical advantage of the disclosed techniques relative to the prior art is that the disclosed techniques enable the automated generation of a multi-device mechanical system that has a quantified performance with respect to one or more design objectives. As a result, for a given mechanical problem, a mechanical system of multiple kinematically linked mechanical devices can be generated that has a desired effectiveness relative to other potential solutions to the mechanical problem. A further technical advantage of the disclosed techniques is that time-consuming and complex engineering tasks can be expedited and/or automated, such as selecting, modifying, and designing mechanical assemblies. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a mechanical system generator, according to various embodiments.

FIG. 2 is a block diagram illustrating the mechanical building block (MBB) library in FIG. 1, according to various embodiments.

FIG. 3A is a schematic illustration of a pulley-belt mechanism that can be an MBB referenced in the MBB library of FIG. 1, according to various embodiments.

FIG. 3B illustrates entries in the MBB library of FIG. 1 that are associated with the pulley-belt mechanism MBB of FIG. 3A, according to various embodiments.

FIG. 4A is a schematic illustration of a spur-gear mechanism that can be an MBB referenced in the MBB library of FIG. 1, according to various embodiments.

FIG. 4B illustrates entries in the MBB library of FIG. 1 that are associated with the spur-gear mechanism MBB of FIG. 4A, according to various embodiments.

FIG. 5A is a schematic illustration of a worm-gear mechanism that can be an MBB referenced in the MBB library of FIG. 1, according to various embodiments.

FIG. 5B illustrates entries in the MBB library of FIG. 1 that are associated with the worm-gear mechanism MBB of FIG. 5A, according to various embodiments.

FIG. 6A is a schematic illustration of a slider mechanism that can be an MBB referenced in the MBB library of FIG. 1, according to various embodiments.

FIG. 6B illustrates entries in the MBB library of FIG. 1 that are associated with the slider mechanism MBB of FIG. 6A, according to various embodiments.

FIG. 7A is a schematic illustration of an L-linkage pivot that can be an MBB referenced in the MBB library of FIG. 1, according to various embodiments.

FIG. 7B illustrates entries in the MBB library of FIG. 1 that are associated with the L-linkage pivot MBB of FIG. 7A, according to various embodiments.

FIG. 8A is a schematic illustration of a four-bar-linkage that can be an MBB referenced in the MBB library of FIG. 1, according to various embodiments.

FIG. 8B illustrates entries in the MBB library of FIG. 1 that are associated with the four-bar-linkage MBB of FIG. 8A, according to various embodiments.

FIG. 9 is an illustration of a constraint graph, according to various embodiments.

FIG. 10 illustrates a mechanical system optimization engine, according to various embodiments.

FIG. 11 sets forth a flowchart of method steps for selecting a configuration of a mechanical system that includes a plurality of mechanical building blocks, according to various embodiments.

FIG. 12A is a schematic diagram of a mechanical system that can be optimized, according to various embodiments.

FIG. 12B is a block diagram illustrating the MBBs that are kinematically linked together to form the mechanical system of FIG. 12A, according to various embodiments.

FIG. 13 sets forth a flowchart of method steps for generating an optimized configuration of a mechanical system for solving a mechanical problem, according to various embodiments.

FIG. 14 is a block diagram of a computing device configured to implement one or more aspects of the various embodiments.

For clarity, identical reference numbers have been used, where applicable, to designate identical elements that are common between figures. It is contemplated that features of one embodiment may be incorporated in other embodiments without further recitation.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

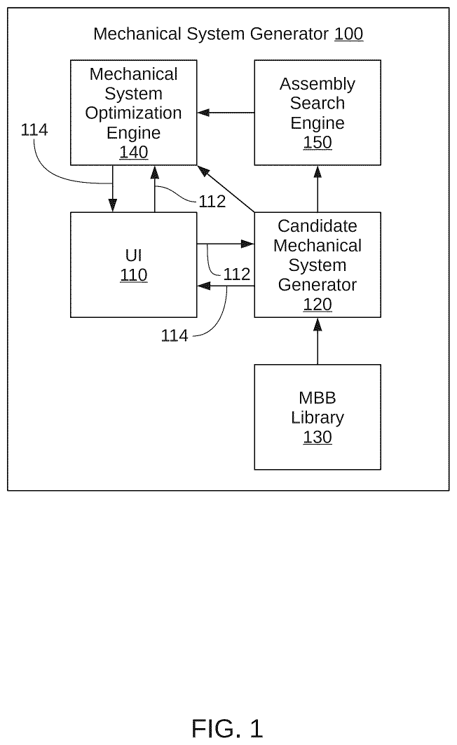

FIG. 1 illustrates a mechanical system generator 100, according to various embodiments. Mechanical system generator 100 is configured to generate a mechanical system that addresses a mechanical problem and includes multiple kinematically linked mechanical devices. Given a specific mechanical problem (for example generating a target mechanical output in response to a given mechanical input) and one or more design objectives (e.g., minimum system weight, minimum system volume, maximum normal force exerted on an article, maximum generated torque, and/or the like), mechanical system generator 100 can generate a mechanical system that solves the mechanical problem. Thus, mechanical system generator 100 can generate a mechanical system that generates the target mechanical output when receiving the mechanical input. For example, in some embodiments, mechanical system generator 100 generates an assembly of multiple kinematically linked mechanical devices that are selected from a library of available mechanical devices (such as one or more pulleys, worm gears, spur gears, linkages, and/or the like). Further, mechanical system generator 100 can determine a set of values for the design variables of each mechanical device in the assembly of kinematically linked mechanical devices. For example, mechanical system generator 100 can provide values for design variables, such as link length, gear-tooth radius, pulley radius, worm-gear diametral pitch, screw pitch angle, and the like, that correspond to a configuration of a mechanical system that has high or optimal performance with respect to the one or more design objectives. In the embodiment shown in FIG. 1, mechanical system generator 100 includes a user interface 110, a candidate mechanical system generator 120, a mechanical building block (MBB) library 130, a mechanical system optimization engine 140, and, in some embodiments, an assembly search engine 150.

User interface (UI) 110 enables a user to provide inputs 112 to and view or otherwise receive outputs 114 from mechanical system generator 100, for example via suitable input/output (I/O) devices. For example, in some embodiments, UI 110 includes a graphical user interface (GUI) that is displayed via a suitable display device. Alternatively, or additionally, in some embodiments, UI 110 includes a command-line interface that enables a user to interact with mechanical system generator 100 via typed commands and text-based output. In some embodiments, the command-line interface can be a terminal window or other text-based window within a GUI. Thus, in some embodiments, inputs 112 and/or outputs 114 can be graphical and/or text-based.

Inputs 112 include one or more indicators, values, or selections that define a mechanical problem to be addressed by the mechanical system to be generated by mechanical system generator 100. Thus, in some embodiments, inputs 112 include one or more indicators, values, or selections corresponding to a mechanical input to the mechanical system to be generated by mechanical system generator 100, such as an input torque, a radius of an input pulley wheel, a rate of rotation of an input shaft, a reciprocating rotational motion, and the like. In some embodiments, inputs 112 further include one or more indicators corresponding to a target mechanical output from the mechanical system to be generated by mechanical system generator 100, such as an output torque, a radius of an output pulley wheel, a rate of rotation of an output shaft, a motion of a component of the mechanical system along a prescribed path, and the like.

Alternatively, or additionally, in some embodiments, inputs 112 can include values corresponding to certain design constraints for the mechanical system to be generated by mechanical system generator 100. For example, in some embodiments, such design constraint values can include a maximum and/or minimum allowable dimension of a candidate mechanical system along a particular axis or along multiple axes. Alternatively, or additionally, in some embodiments, such design constraint values can include a maximum and/or minimum value for some other attribute of the candidate mechanical systems, such as a maximum allowable weight. Alternatively, or additionally, in some embodiments, such design constraint values can include one or more values indicating specific design objectives (e.g., weight, tensile strength, deflection, and the like) that define the objective function for the optimization process performed by mechanical system generator 100. Generally, the objective function is associated with a specific design requirement or combination of design requirements. Alternatively, or additionally, in some embodiments, such design constraint values can include a maximum and/or minimum value for certain design variables associated with a particular mechanical device that can be included in the candidate mechanical system, such as a maximum link length of a horizontal link in a four-bar linkage, a minimum gear-tooth radius for a spur gear, and the like. Alternatively, or additionally, in some embodiments, such design constraint values can include a maximum or minimum value for certain state variables of the candidate mechanical system (e.g., rotational or translational velocity of a joint or link, displacement of a joint along a particular axis of translation, etc.)

In some embodiments, inputs 112 can include one or more MBBs to be included in a candidate mechanical system, thereby constraining the total number of possible candidate mechanical systems for a given problem. For example, in some embodiments, a particular MBB (or a kinematically linked set of multiple MBBs) can be specified in inputs 112 as the MBB (or set of MBBs) of candidate mechanical systems that receives the mechanical input to the mechanical system. Alternatively, or additionally, in some embodiments, a particular MBB (or a kinematically linked set of multiple MBBs) can be specified in inputs 112 as the MBB (or set of MBBs) of candidate mechanical systems that generates the mechanical output from the mechanical system. Alternatively, or additionally, in some embodiments, a particular MBB (or a kinematically linked set of multiple MBBs) can be specified in inputs 112 as an MBB (or set of MBBs) that is to be included at least once within the kinematic chain of some or all candidate mechanical systems.

In some embodiments, inputs 112 can include information related to specific MBBs to be included in a candidate mechanical system to be optimized by mechanical system optimizer engine 140, for example as defined by a user. For example, in some embodiments, inputs 112 can include one or more indicators corresponding to a specific kinematic coupling between two MBBs included in the candidate mechanical system. Alternatively, or additionally, in some embodiments, inputs 112 can include values for certain design variables of each MBB or component of each MBB included in the candidate mechanical system that are fixed, such as link length, gear-tooth radius, pulley radius, worm-gear diametral pitch, cross-sectional area of a component of the MBB, density and/or other materials properties of a component of the MBB, and the like. Alternatively, or additionally, in some embodiments, inputs 112 can include initial values for particular design variables of each MBB or component of each MBB included in the candidate mechanical system. In such embodiments, subsequent optimization performed by mechanical system optimizer engine 140 can begin using the initial values for the particular design variables.

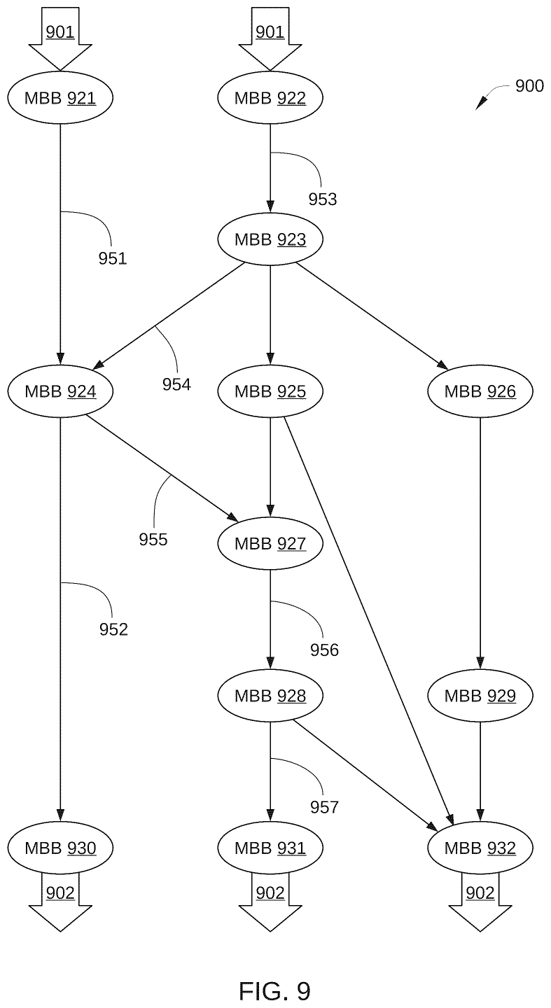

Outputs 114 can include graphical and/or text-based information associated with one or more configurations of one or more optimized candidate mechanical systems generated by mechanical system generator 100. For example, in some embodiments, outputs 114 can include a graphical or text-based representation of an optimal or high-performing configuration of the optimized candidate mechanical system(s) generated by mechanical system generator 100. In such a embodiments, the configuration can include values for the various optimized design variables determined by mechanical system generator 100. Alternatively, or additionally, outputs 114 can include the performance of the optimal or high-performing configuration with respect to the objective function, for example via a performance score that quantifies a performance of a corresponding candidate mechanical system with respect to an objective function. In some embodiments, outputs 114 can include graphical and/or text-based information associated with multiple configurations of the optimized candidate mechanical system(s) generated by mechanical system generator 100, such as the five highest-scoring optimized configurations of a particular optimized candidate mechanical system and the associated design variable values, or the five highest-scoring optimized candidate mechanical systems of a particular optimized candidate mechanical system. Alternatively, or additionally, outputs 114 can include a constraint graph of the multiple candidate mechanical systems generated by candidate mechanical system generator 120. In such embodiments, the constraint graph functions as a graphical comparison of the multiple candidate mechanical systems generated by candidate mechanical system generator 120 for solving a particular mechanical problem. In such embodiments, the constraint graph can enable comparison of all possible candidate mechanical systems generated by candidate mechanical system generator 120 for solving the particular mechanical problem, or some subset of all possible candidate mechanical systems generated by candidate mechanical system generator 120. One embodiment of a constraint graph is described below in conjunction with FIG. 9.

MBB library 130 stores information associated with a plurality of MBBs that can be combined to form different mechanical assemblies into a candidate mechanical system that can address the mechanical problem indicated in inputs 112. Generally, each MBB represented in MBB library 130 is a mechanical device that can be kinematically linked to one or more other MBBs to form a mechanical assembly or system that generates a specific mechanical output in response to a specific mechanical input. Examples of such MBBs include, without limitation, a pulley belt, various gears (e.g., a spur gear, a worm gear, a helical gear, a rack and pinion, a bevel gear, a screw gear, a miter gear, and the like) a shaft, a slider, various linkages, (e.g., an L-linkage pivot, a four-bar linkage, a reverse-motion linkage, a push-pull linkage, a parallel-motion linkage, a bell-crank linkage, and the like), various slider-rockers, a lever, a cam and follower, and the like.

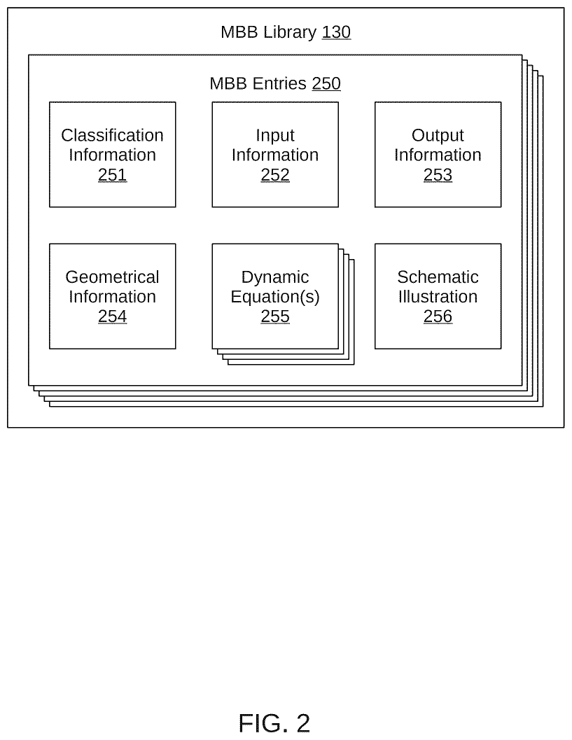

For each MBB represented in MBB library 130, MBB library 130 stores a governing dynamic equation (or in some instances a system of multiple dynamic equations) and a list of applicable design variables and state variables referenced in the governing dynamic equation. In addition, for each MBB represented in MBB library 130, MBB library 130 stores the mechanical input the MBB receives when in operation and a target mechanical output from the mechanical system when in operation. Examples of such mechanical inputs include, without limitation, rotation at a specific rotational speed of an input shaft or gear, translation of a component (link or joint) of the MBB in a particular direction, an input torque, and the like. Examples of target mechanical outputs include, without limitation, rotation at a specific rotational speed of an output shaft or gear, translation of a component of the MBB in a particular direction, an output torque, motion of a component of the MBB along a prescribed path, and the like. One embodiment of MBB library 130 is described below in conjunction with FIG. 2.

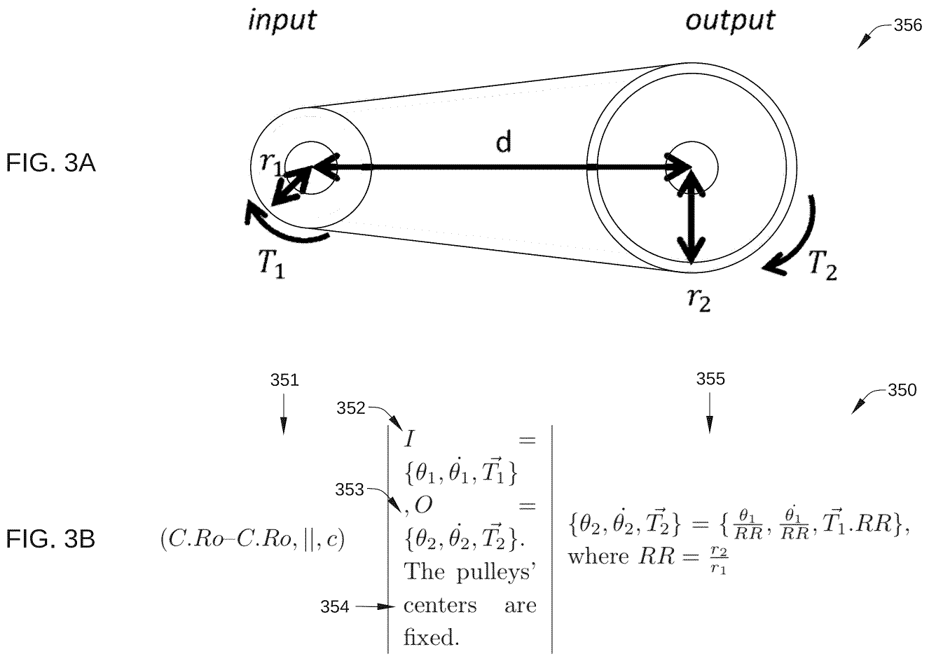

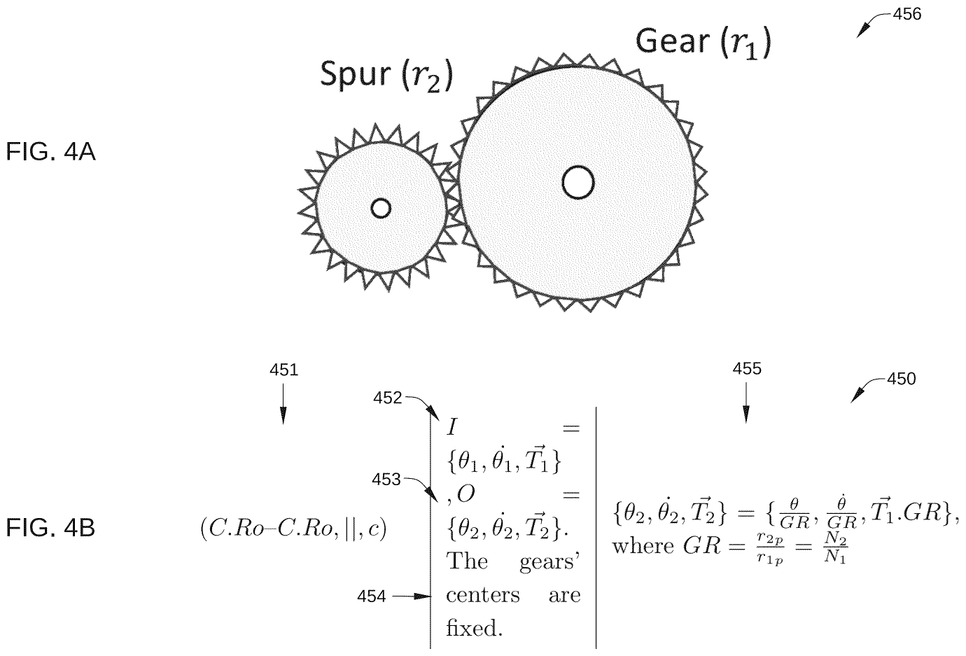

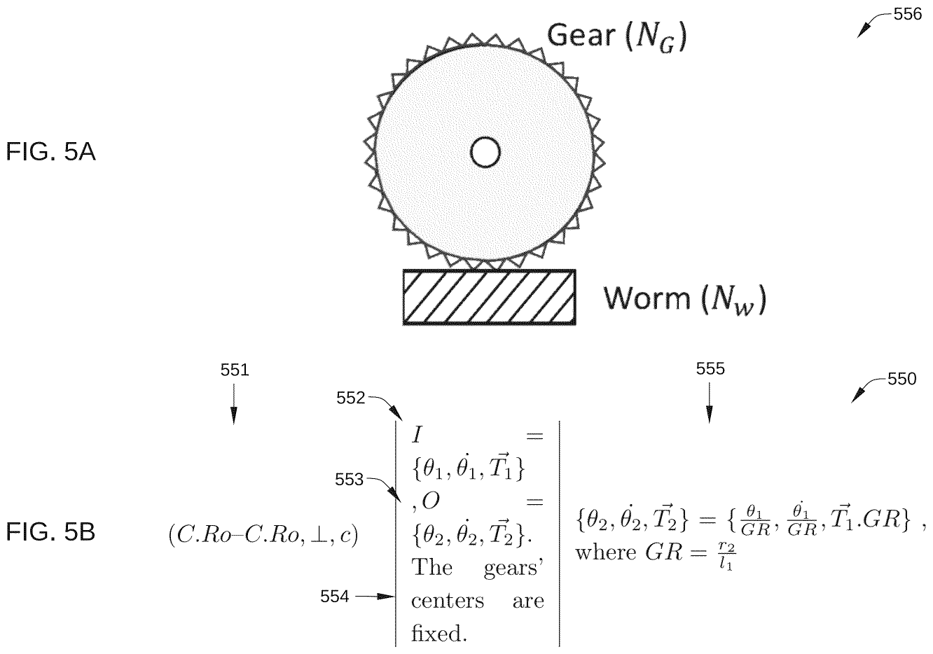

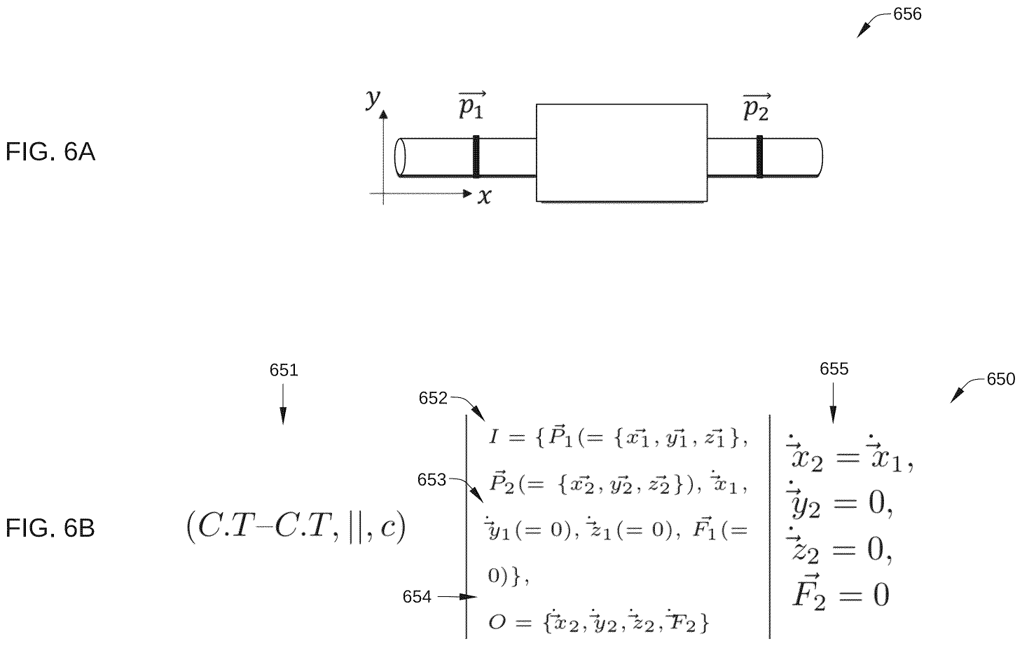

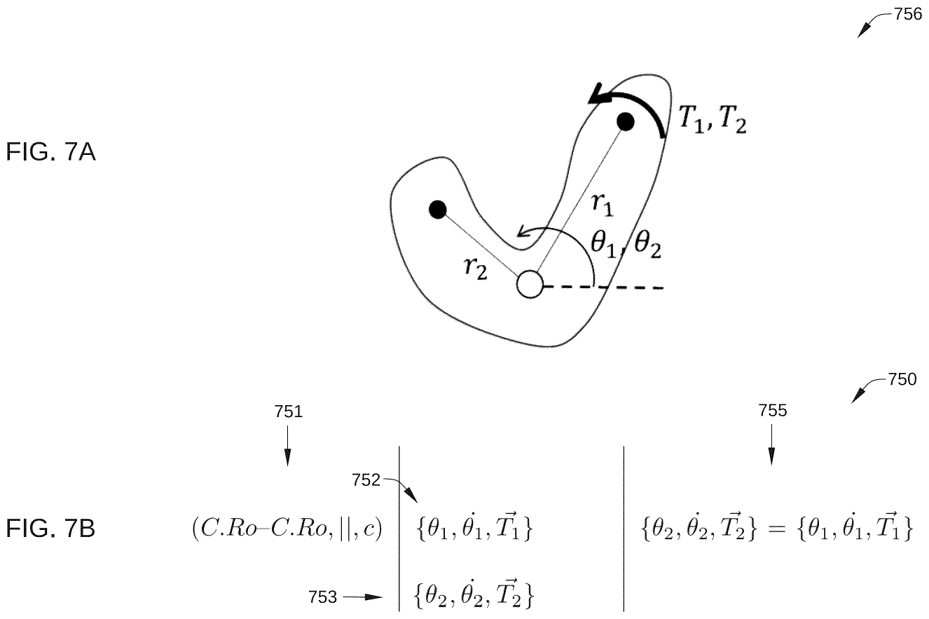

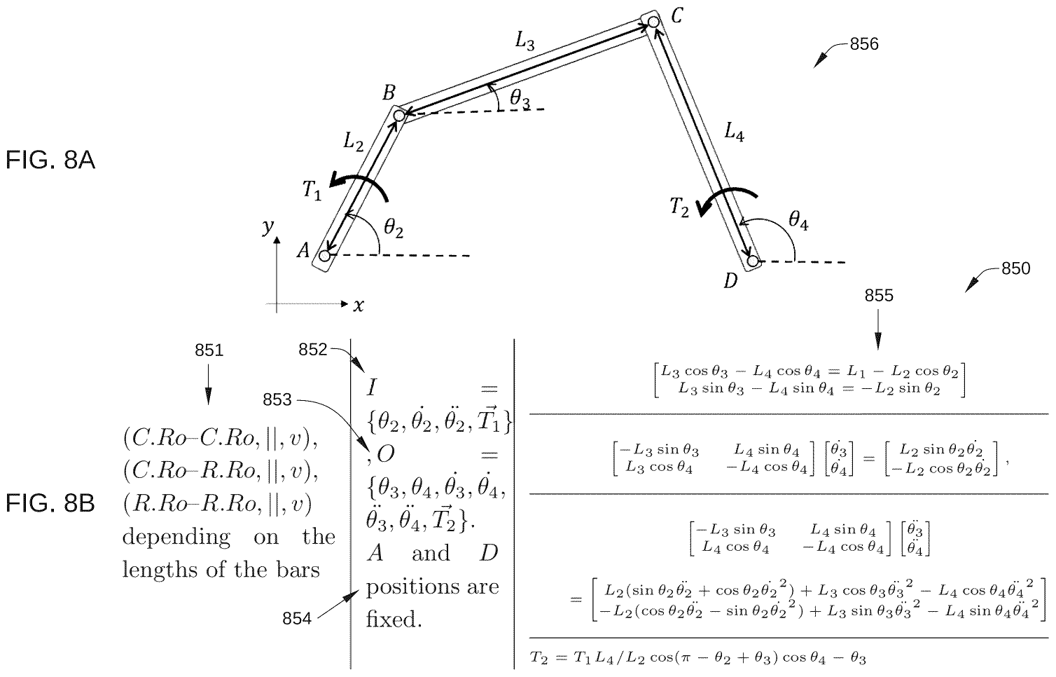

FIG. 2 is a block diagram illustrating MBB library 130, according to various embodiments. As shown, MBB library 130 includes information for a plurality of MBBs. In the embodiment illustrated in FIG. 2, MBB library 130 includes such information as MBB entries 250. In some embodiments, for a particular MBB referenced in MBB library 130, MBB entries 250 can include, without limitation, classification information 251, input information 252, output information 253, geometrical information 254, dynamic equation(s) 255, and a schematic illustration 256. Example embodiments of MBB entries 250 stored in MBB library 130 for various commonly employed MBBs are described below. Specifically, MBB entries for a pulley-belt mechanism are described below in conjunction with FIGS. 3A and 3B, MBB entries for a spur-gear mechanism are described below in conjunction with FIGS. 4A and 4B, MBB entries for a worm-gear mechanism are described below in conjunction with FIGS. 5A and 5B, MBB entries for a slider mechanism are described below in conjunction with FIGS. 6A and 6B, MBB entries for an L-linkage pivot are described below in conjunction with FIGS. 7A and 7B, and MBB entries for a four-bar linkage are described below in conjunction with FIGS. 8A and 8B.

FIG. 3A is a schematic illustration 356 of a pulley-belt mechanism that can be an MBB referenced in MBB library 130, according to various embodiments. In some embodiments, schematic illustration 356 can be included as one of entries 350 in MBB library 130 that is associated with the pulley-belt mechanism MBB. For example, schematic illustration 356 can be displayed by UI 110 in FIG. 1 to facilitate user interactions with mechanical system generator 100 when reviewing a candidate mechanical system generated by mechanical system generator 100 that includes a pulley-belt mechanism MBB and/or when providing inputs 112 associated with the pulley-belt mechanism MBB.

Schematic illustration 356 depicts geometrical and/or physical attributes of a pulley-belt mechanism that are pertinent to and/or referenced by a dynamic equation associated with the pulley-belt mechanism MBB referenced in MBB library 130. Thus, in the embodiment illustrated in FIG. 3A, schematic illustration 356 includes an input torque T₁, an output torque T₂, a radius r₁ of an input pulley wheel and a radius r₂ of an output pulley wheel. In the embodiment illustrated in FIG. 3A, radius r₁ and radius r₂ are design variables for the pulley-belt mechanism MBB, and values for these design variables are determined by mechanical system generator 100 during an optimization process as described below. In other embodiments, additional design variables may be associated with the pulley-belt mechanism MBB. In the embodiment illustrated in FIG. 3A, input torque T₁, output torque T₂, radius r₁ and radius r₂ are referenced in other entries in MBB library 130 that are associated with the pulley-belt mechanism MBB. Examples of such entries are described below in conjunction with FIG. 3B.

FIG. 3B illustrates entries 350 in MBB library 130 that are associated with the pulley-belt mechanism MBB referenced in MBB library 130, according to various embodiments. In the embodiment illustrated in FIG. 3B, entries 350 include classification information 351, input information 352, output information 353, geometrical information 354, and a dynamic equation 355. In other embodiments, additional entries may be included for some or all MBBs referenced in MBB library 130.

Classification information 351 classifies the foundation information of the pulley-belt mechanism MBB. In the embodiment illustrated in FIG. 3B, classification information 351 includes data about input motion, output motion, a relative angle of the mechanical input and mechanical output (perpendicular or parallel), and speed information. Input information 352 indicates the input variables (I=) for the pulley-belt mechanism MBB that define a mechanical input that can be received by the pulley-belt mechanism MBB, and output information 353 indicates the output variables (O=) for the pulley-belt mechanism MBB that define a mechanical output generated by the pulley-belt mechanism MBB. Geometrical information 354 indicates, for some MBBs, applicable geometrical information or clarification notes pertaining to the pulley-belt mechanism MBB. Dynamic equation 355 provides the equation to obtain appropriate position, velocity, acceleration (where applicable), and/or force/torque values for the pulley-belt mechanism MBB. In some embodiments, for more complex MBBs, dynamic equation 355 is implemented as a system of equations, such as in the case of a four-bar linkage (described below in conjunction with FIGS. 8A and 8B). In either case, dynamic equation(s) 355 enforce the dynamics of the associated MBB, as well as physical and geometrical constraints indicated in inputs 112.

FIG. 4A is a schematic illustration 400 of a spur-gear mechanism that can be an MBB referenced in MBB library 130, according to various embodiments. In some embodiments, schematic illustration 456 can be included as one of entries 450 in MBB library 130 that is associated with the spur-gear mechanism MBB, and otherwise can be consistent with schematic illustration 356 in FIG. 3A. For example, schematic illustration 400 can be displayed by UI 110 in FIG. 1 to facilitate user interactions with mechanical system generator 100 when reviewing a candidate mechanical system generated by mechanical system generator 100 that includes a spur-gear mechanism MBB and/or when providing inputs 112 associated with the spur-gear mechanism MBB.

FIG. 4B illustrates entries 450 in MBB library 130 that are associated with the spur-gear mechanism MBB referenced in MBB library 130, according to various embodiments. Entries 450 can be consistent with entries 250 in FIG. 2 and/or entries 350 in FIGS. 3A and 3B, except for MBB-specific information included therein. For example, in the embodiment illustrated in FIG. 4B, entries 450 include classification information 451, input information 452, output information 453, geometrical information 454, and a dynamic equation 455.

FIG. 5A is a schematic illustration 500 of a worm-gear mechanism that can be an MBB referenced in MBB library 130, according to various embodiments. In some embodiments, schematic illustration 556 can be included as one of entries 550 in MBB library 130 that is associated with the worm-gear mechanism MBB, and otherwise can be consistent with schematic illustration 356 in FIG. 3A. For example, schematic illustration 500 can be displayed by UI 110 in FIG. 1 to facilitate user interactions with mechanical system generator 100 when reviewing a candidate mechanical system generated by mechanical system generator 100 that includes a worm-gear mechanism MBB and/or when providing inputs 112 associated with the worm-gear mechanism MBB.

FIG. 5B illustrates entries 550 in MBB library 130 that are associated with the worm-gear mechanism MBB referenced in MBB library 130, according to various embodiments. Entries 550 can be consistent with entries 250 in FIG. 2 and/or entries 350 in FIGS. 3A and 3B, except for MBB-specific information included therein. For example, in the embodiment illustrated in FIG. 5B, entries 550 include classification information 551, input information 552, output information 553, geometrical information 554, and a dynamic equation 555.

FIG. 6A is a schematic illustration 600 of a slider mechanism that can be an MBB referenced in MBB library 130, according to various embodiments. In some embodiments, schematic illustration 656 can be included as one of entries 650 in MBB library 130 that is associated with the slider mechanism MBB, and otherwise can be consistent with schematic illustration 356 in FIG. 3A. For example, schematic illustration 600 can be displayed by UI 110 in FIG. 1 to facilitate user interactions with mechanical system generator 100 when reviewing a candidate mechanical system generated by mechanical system generator 100 that includes a slider mechanism MBB and/or when providing inputs 112 associated with the slider mechanism MBB.

FIG. 6B illustrates entries 650 in MBB library 130 that are associated with the slider mechanism MBB referenced in MBB library 130, according to various embodiments. Entries 650 can be consistent with entries 250 in FIG. 2 and/or entries 350 in FIGS. 3A and 3B, except for MBB-specific information included therein. For example, in the embodiment illustrated in FIG. 6B, entries 650 include classification information 651, input information 652, output information 653, geometrical information 654, and a system of multiple dynamic equations 655.

FIG. 7A is a schematic illustration 700 of an L-linkage pivot that can be an MBB referenced in MBB library 130, according to various embodiments. In some embodiments, schematic illustration 756 can be included as one of entries 750 in MBB library 130 that is associated with the L-linkage pivot MBB, and otherwise can be consistent with schematic illustration 356 in FIG. 3A. For example, schematic illustration 700 can be displayed by UI 110 in FIG. 1 to facilitate user interactions with mechanical system generator 100 when reviewing a candidate mechanical system generated by mechanical system generator 100 that includes an L-linkage pivot MBB and/or when providing inputs 112 associated with the L-linkage pivot MBB.

FIG. 7B illustrates entries 750 in MBB library 130 that are associated with the L-linkage pivot MBB referenced in MBB library 130, according to various embodiments. Entries 750 can be consistent with entries 250 in FIG. 2 and/or entries 350 in FIGS. 3A and 3B, except for MBB-specific information included therein. For example, in the embodiment illustrated in FIG. 7B, entries 750 include classification information 751, input information 752, output information 753, and a dynamic equation 755.

FIG. 8A is a schematic illustration 800 of a four-bar-linkage that can be an MBB referenced in MBB library 130, according to various embodiments. In some embodiments, schematic illustration 856 can be included as one of entries 850 in MBB library 130 that is associated with the four-bar-linkage MBB, and otherwise can be consistent with schematic illustration 356 in FIG. 3A. For example, schematic illustration 800 can be displayed by UI 110 in FIG. 1 to facilitate user interactions with mechanical system generator 100 when reviewing a candidate mechanical system generated by mechanical system generator 100 that includes a four-bar linkage MBB and/or when providing inputs 112 associated with the four-bar-linkage MBB.

FIG. 8B illustrates entries 850 in MBB library 130 that are associated with the four-bar-linkage MBB referenced in MBB library 130, according to various embodiments. Entries 850 can be consistent with entries 250 in FIG. 2 and/or entries 350 in FIGS. 3A and 3B, except for MBB-specific information included therein. For example, in the embodiment illustrated in FIG. 8B, entries 850 include classification information 851, input information 852, output information 853, geometrical information 854, and a system of multiple dynamic equations 855.

Returning to FIG. 1, candidate mechanical system generator 120 is configured to generate one or more candidate mechanical systems. According to various embodiments, each candidate mechanical system can address the mechanical problem defined by inputs 112, where the candidate mechanical system addresses the mechanical problem of interest by generating the target mechanical output when receiving the specified mechanical input. Generally, a candidate mechanical system includes multiple kinematically linked mechanical devices, such as one or more pulleys, worm gears, spur gears, linkages, and/or the like. Each mechanical device and the associated entries is referred to herein as an MBB.

To generate a candidate mechanical system, candidate mechanical system generator 120 selects a chain of kinematically compatible MBBs from MBB library 130 and combines the selected MBBs to form an assembly, where the assembly satisfies a desired motion transformation from the mechanical input motion to the target mechanical output motion. A first MBB and a second MBB are considered kinematically compatible MBBs when a mechanical output associated with the first MBB corresponds to the mechanical input associated with the second MBB. For example, in an instance in which the mechanical output associated with the first MBB is rotation of a shaft, the second kinematically compatible MBB can be any MBB in MBB library 130 that has a mechanical input that is rotation of a shaft (or a component that can be coupled to a rotating shaft, such as a spur gear). Generally, for a particular mechanical problem, candidate mechanical system generator 120 generates a plurality of candidate mechanical systems, where each candidate mechanical system includes a different kinematic chain for generating the target mechanical output from the mechanical input specified for the problem.

According to various embodiments, some or all of the candidate mechanical systems generated by candidate mechanical system generator 120 for a particular mechanical problem are optimized by mechanical system optimization engine 140. It is noted that there is a large number of different MBBs that are commonly employed in industry for assembling mechanical systems. Further, there can be a plurality of different MBBs capable of performing one particular motion transformation. For example, given a need for an MBB in a kinematic chain that transforms rotational motion (the mechanical input to the MBB) to translational motion (the target mechanical output of the MBB), the possible MBBs capable of performing such motion transformation can include a slider crank mechanism, a rack-and-pinion mechanism, a screw mechanism, a rope-and-pulley mechanism, and a cam mechanism, among others. Consequently, for a particular mechanical problem, there can be a very large number of possible permutations of MBBs that can potentially address the problem by transforming a given mechanical input into a target mechanical output. As a result, in some embodiments, mechanical system optimization engine 140 generates an optimized configuration for selected candidate mechanical systems generated by candidate mechanical system generator 120 rather than for each candidate mechanical system generated by candidate mechanical system generator 120.

In some embodiments, to limit the number of candidate mechanical systems generates for a particular mechanical problem, candidate mechanical system generator 120 does not determine every possible permutation of MBBs available in MBB library 130 that can generate the target mechanical output when receiving the specified mechanical input. For example, in some embodiments, for a particular mechanical problem, candidate mechanical system generator 120 generates candidate mechanical systems for a specific time interval, then halts. Alternatively, or additionally, in some embodiments, for a particular mechanical problem, candidate mechanical system generator 120 generates a specific number of candidate mechanical systems, then halts. Alternatively, or additionally, in some embodiments, for a particular mechanical problem, candidate mechanical system generator 120 generates candidate mechanical systems that can generate the target mechanical output and include no more than a threshold number of MBBs. Thus, in such embodiments, candidate mechanical system generator 120 does not generate candidate mechanical systems that have more MBBs than the threshold number of MBBs.

In some embodiments, to facilitate user selection of one or more candidate mechanical systems for optimization, candidate mechanical system generator 120 provides a graphical summary of the candidate mechanical systems that have been generated. In such embodiments, the graphical summary can be a constraint graph that enables the visual comparison of some or all generated candidate mechanical systems simultaneously. One embodiment of a constraint graph is described below in conjunction with FIG. 9.

FIG. 9 is an illustration of a constraint graph 900, according to various embodiments. When displayed to a user, constraint graph 900 enables visual comparison of some or all of the candidate mechanical systems generated by candidate mechanical system generator 120 for solving a particular mechanical problem. In the embodiment illustrated in FIG. 9, constraint graph 900 includes MBBs 921-932 that are kinematically linked by motions that include motions 951-957, and the mechanical problem is defined by a mechanical input 901 and a target mechanical output 902. In addition, each candidate mechanical system is defined by a path of kinematically linked MBBs between mechanical input 901 and a target mechanical output 902. For example, a first candidate mechanical system corresponds to the path indicated by MBB 921 (which receives mechanical input 901), motion 951 (which is output from MBB 921), MBB 924 (which is suitable for receiving motion 951), motion 952 (which is output from MBB 924), and MBB 930 (which generates mechanical output 902 in response to receiving motion 952). In another example, a second candidate mechanical system corresponds to the path indicated by MBB 922, motion 953, MBB 923, motion 954, MBB 924, motion 955, MBB 927, motion 956, MBB 928, motion 957, and MBB 931. In addition to the above-described first and second candidate mechanical systems, constraint graph 900 further indicates a plurality of other candidate mechanical systems that are also available to solve the mechanical problem associated with mechanical input 901 and target mechanical output 902.

Review of constraint graph 900 enables a user to visually compare the relative complexity of the various candidate mechanical systems generated by candidate mechanical system generator 120. In some embodiments, constraint graph 900 can include MBB-specific information for each MBB included therein, such as a device type, an input motion descriptor, an output motion descriptor, and/or the like. Thus, in such embodiments, the user is enabled to quickly ascertain, for example, the specific mechanical device and/or mechanical motions associated with each MBB in a particular candidate mechanical system.

Returning to FIG. 1, assembly search engine 150 enables automated selection of candidate mechanical systems for optimization by mechanical system optimization engine 140. Thus, in some embodiments, mechanical system generator 100 selects certain candidate mechanical systems for optimization by mechanical system optimization engine 140 instead of a user. In such embodiments, assembly search engine 150 can select the candidate mechanical systems to be optimized based on one or more criteria. In some embodiments, assembly search engine 150 selects candidate mechanical systems based on the total number of MBBs included in each candidate mechanical systems. For example, in some embodiments, assembly search engine 150 selects the candidate mechanical systems that have less than a threshold number of MBBs. In such embodiments, assembly search engine 150 selects the candidate mechanical systems that are less complex for optimization. Alternatively, or additionally, in some embodiments, assembly search engine 150 selects the candidate mechanical systems using a combinatorial search algorithm. For example, in some embodiments, certain types of MBBs can historically be more likely to provide an optimal solution for certain mechanical problems than other MBBs. Thus, in such embodiments, based on the mechanical input, the mechanical output, and one or more MBBs associated with optimal solutions for the mechanical problem, the combinatorial algorithm can favorably weight selection of generated candidate mechanical systems that include such MBBs. In another example, in some embodiments, certain combinations of MBBs can historically be more likely to provide an optimal solution for a mechanical problem than other combinations of MBBs. Thus, in such embodiments, based on the mechanical input, the mechanical output, and one or more combinations of MBBs associated with optimal solutions for the mechanical problem, the combinatorial algorithm can weight selection of candidate mechanical systems that include one or more such combinations of MBBs.

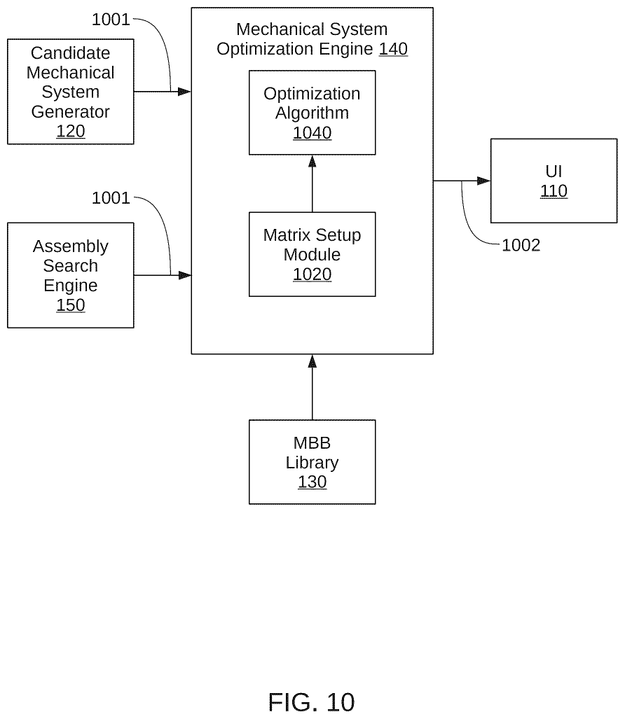

Mechanical system optimizer engine 140 is configured to generate a configuration of a candidate mechanical system generated by candidate mechanical system generator 120. As noted above, each candidate mechanical system generated by candidate mechanical system generator 120 includes multiple kinematically linked mechanical devices (MBBs) and addresses a mechanical problem. Thus, given an assembly of kinematically linked mechanical devices (including, for example, one or more pulleys, worm gears, spur gears, linkages, and/or the like) and one or more design objectives (e.g., minimum system weight, minimum system volume, maximum normal force exerted on an article, maximum generated torque, and/or the like), mechanical system optimizer engine 140 can determine a set of values for the design variables of each mechanical device. For example, mechanical system optimizer engine 140 can provide values for design variables, such as link length, gear-tooth radius, pulley radius, worm-gear diametral pitch, screw pitch angle, and the like, that correspond to a configuration of a mechanical system that has high or optimal performance with respect to the one or more design objectives. In some embodiments, mechanical system optimizer engine 140 can generate a high- or optimal-performance configuration of a mechanical system that addresses a multi-disciplinary mechanical problem, in which two or more design objectives are drawn from different relevant disciplines and are considered simultaneously during optimization. One embodiment of mechanical system optimization engine 140 is described below in conjunction with FIG. 10.

FIG. 10 illustrates mechanical system optimization engine 140, according to various embodiments. In the embodiment shown in FIG. 1, mechanical system optimization engine 140 includes a matrix set-up module 1020 and an optimization algorithm 1040. In operation, mechanical system optimization engine 140 receives a candidate mechanical system 1001 (for example from candidate mechanical system generator 120 or assembly search engine 150) and information from MBB library 130 that is associated with candidate mechanical system 1001. Mechanical system optimization engine 140 then generates an optimized mechanical system 1002 and transmits optimized mechanical system 1002 to UI 110.

Matrix set-up module 1020 translates information associated with a specific candidate mechanical system 1001 into a format that enables optimization algorithm to generate one or more optimal or high-performing configurations of candidate mechanical system 1001. For example, in some embodiments, matrix-set-up module 1020 generates a system matrix for candidate mechanical system 1001 that can be employed by optimization algorithm 1040 to determine an optimal and/or high-performing configuration of candidate mechanical system 1001.

In some embodiments, matrix set-up module 1020 determines a set of dynamic equations for candidate mechanical system 1001 based on information included in inputs 112, then constructs a system matrix based on the set of dynamic equations. For example, in some embodiments, matrix set-up module 1020 determines a dynamic equation for each MBB indicated in candidate mechanical system 1001 and/or inputs 112 to be included in the mechanical system. In some embodiments, matrix set-up module 1020 determines the dynamic equation for each MBB included in candidate mechanical system 1001 based on information stored in MBB library 130 and associated with the MBB, such as dynamic equation 255 in FIG. 2B.

Generally, the system matrix constructed by matrix set-up module 1020 has a matrix size of N×M, where N is the number of MBB dynamic equations incorporated into the system matrix and M is the total number of state variables and design variables in the MBB dynamic equations incorporated into the system matrix. In some embodiments, a modular analysis and unified derivatives (MAUD) architecture is applied to the MBB dynamic equations to construct the system matrix. The MAUD architecture is widely used for multidisciplinary design optimization (MDO) problems, and formulates the multidisciplinary model as a nonlinear system of equations. In other embodiments, matrix set-up module 1020 can employ any other technically feasible approach to construct the system matrix.

In some embodiments, the system matrix corresponds to the Jacobian of candidate mechanical system 1001 as defined by the MBB dynamic equations of candidate mechanical system 1001. The Jacobian includes the derivatives of the state variables with respect to one or more different variables, such as time.

Optimization algorithm 1040 determines a set of parametric values for the set of dynamic equations of candidate mechanical system 1001 via parametric optimization. The set of parametric values determined by optimization algorithm 1040 defines a specific configuration of candidate mechanical system 1001. For example, in an embodiment, the set of parametric values includes a value for some or all design variables (e.g., link length, gear-tooth radius, pulley radius, worm-gear diametral pitch, etc.) for the MBBs included in candidate mechanical system 1001. Taken together, the set of parametric values indicates an optimal overall solution or high-performing overall solution for candidate mechanical system 1001 with respect to the one or more specific design objectives included in inputs 112. Thus, given an assembly of kinematically linked mechanical devices (including, for example, one or more pulleys, worm gears, spur gears, linkages, and/or the like) and one or more design objectives, optimization algorithm 1040 determines an optimal or high-performing solution to a mechanical problem based on a specific instance of candidate mechanical system 1001.

To determine the set of parametric values for the MBB dynamic equations that form the system matrix, optimization algorithm 1040 performs non-linear, gradient-based optimization by solving the system Jacobian matrix. Optimization algorithm 1040 can include any technically feasible gradient-based optimization algorithm or algorithms for performing such gradient-based optimization. For example, in an embodiment, optimization algorithm 1040 includes IPOPT (Interior Point Optimizer) for performing the large-scale nonlinear optimization typically employed to determine the set of parametric values.

Typically, the dynamic equations associated with the MBBs included in a particular instance of candidate mechanical system 1001 include kinematic and/or time-dependent equations. As a result, to determine an optimal or high-performing solution, the rate of change of the state variables with respect to time is also considered by optimization algorithm 1040, in addition to the sensitivity of the objective function with respect to the design variables. Consequently, in some embodiments, optimization algorithm 1040 discretizes the dynamic equations associated with the MBBs. For example, in some embodiments, optimization algorithm 1040 employs the well-known collocation method, which is a direct optimization method based on an implicit integration technique. Collocation involves approximating a system's responses at several points (collocation points) within a design space. By analyzing these points, optimization algorithm 1040 can predict behavior of the particular instance of candidate mechanical system 1001 across the entire design space, enhancing the accuracy and efficiency of the optimization algorithm 1040. Thus, in such embodiments, the system matrix has a matrix size of N×(M×t), where t is the number of discrete collocation points.

### Parametric Optimization of a Candidate Mechanical System

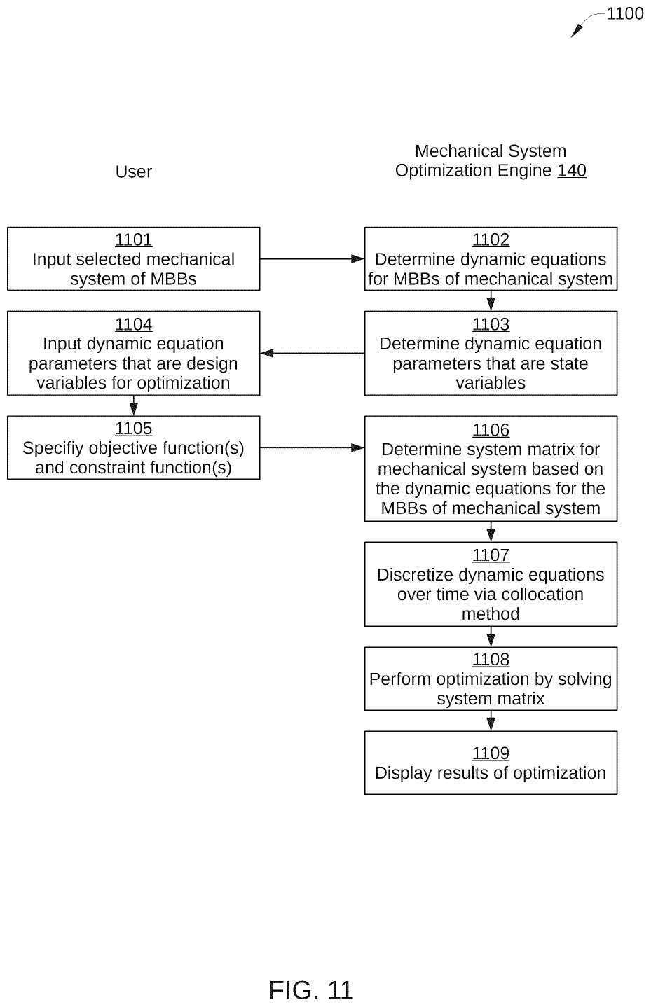

FIG. 11 sets forth a flowchart of method steps for selecting a configuration of a mechanical system that includes a plurality of mechanical building blocks, according to various embodiments. Although the method steps are described in conjunction with the system of FIG. 1, persons skilled in the art will understand that any suitable system configured to perform the method steps, in any order, is within the scope of the embodiments.

A computer-implemented method 1100 begins at step 1101, where a user inputs two or more MBBs that form a candidate mechanical system. For example, in some embodiments, the user provides inputs 112 to UI 110 indicating two or more MBBs and how the MBBs are kinematically linked. Alternatively, the candidate mechanical system of kinematically linked MBBs can be provided automatically, for example via a mechanical system design application such as candidate mechanical system generator 120, a machine-learning-based design application, or other software application.

In step 1102, mechanical system optimizer engine 140 determines the applicable dynamic equations for the MBBs of the candidate mechanical system input in step 1101, for example via matrix set-up module 1020. For example, in some embodiments, matrix set-up module 1020 determines the applicable dynamic equations for each MBB in the candidate mechanical system using entries in MBB library 130 that are associated with each MBB, such as entries 250 in FIG. 2B. In step 1103, mechanical system optimizer engine 140 determines the parameters of the dynamic equations for each MBB that is a state variable, such as rotational or translational velocity of a joint or link, displacement of a joint along a particular axis of translation, input torque to an MBB, output torque from an MBB, and the like. In some embodiments, the state variables for each MBB that is referenced in MBB library 130 can be stored in MBB library 130 prior to method 1100.

In step 1104, a user inputs dynamic equation parameters that are design variables to be optimized, for example via inputs 112. Alternatively, in some embodiments, mechanical system optimizer engine 140 determines the dynamic equation parameters that are design variables to be optimized. Generally, each design variable corresponds to an attribute or feature of an MBB included in the candidate mechanical system, such as link length, gear-tooth radius, pulley radius, worm-gear diametral pitch, screw pitch angle, and the like. Taken together, the design variables describe the various configurations of the candidate mechanical system that are possible to be implemented. In some embodiments, the user is prompted for entry of the design variables via UI 110.

In step 1105, a user inputs one or more design objectives or objective functions, for example via inputs 112. For example, in some embodiments, an objective function is associated with a specific design requirement or combination of design requirements for the candidate mechanical system. In some embodiments, in step 1105 the user also inputs one or more constraint values or constrain functions for the candidate mechanical system, for example via inputs 112. Examples of such design constraints include maximum or minimum values for certain state variables of the candidate mechanical system and maximum or minimum values for certain design variables of the candidate mechanical system.

In step 1106, mechanical system optimizer engine 140 determines a system matrix based on the set of dynamic equations determined in step 1102, for example via matrix set-up module 1020. In some embodiments, matrix set-up module 1020 determines a dynamic equation or system of dynamic equations for each MBB indicated in inputs 112 to be included in the candidate mechanical system.

In step 1107, mechanical system optimizer engine 140 discretizes the system matrix over time, for example via optimization algorithm 1040. In some embodiments, optimization algorithm 1040 employs a collocation method in step 1107.

In step 1108, mechanical system optimizer engine 140 solves the system matrix, via an optimization process, to determine a set of parametric values for the set of dynamic equations. In some embodiments, optimization algorithm employs parametric optimization. The set of parametric values is associated with a specific mechanical configuration of the candidate mechanical system that has optimal or high performance with respect to the one or more design objectives input in step 1105.

In step 1109, mechanical system optimizer engine 140 displays the results of the optimization process performed in step 1108, for example via output 114.

### Exemplary Optimization Case Study

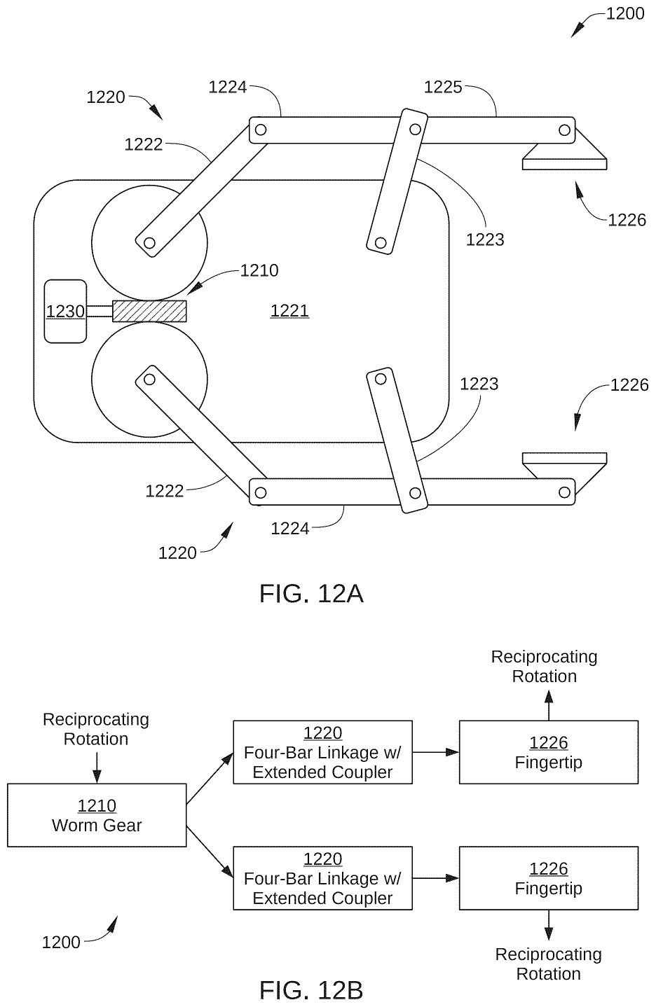

FIG. 12A is a schematic diagram of a mechanical system 1200 that can be optimized, according to various embodiments. FIG. 12B is a block diagram illustrating the MBBs that are kinematically linked together to form mechanical system 1200. In operation, mechanical system 1200 grasps an object (not shown) given certain clearances and the position of the object. As shown in FIG. 12B, reciprocating rotation (e.g., of a motor 1230) causes an output reciprocating rotation of fingertips 1226.

In the embodiment illustrated in FIG. 12, mechanical system 1200 is implemented as a gripper assembly, which is widely used for various tasks in many different industries. As shown, mechanical system 1200 includes three kinematically linked MBBs: worm-gear 1210 and two four-bar linkages 1220. Each four-bar linkage 1220 includes bar 1221 (fixed), 1222, 1223, and 1224, where bar 1224 includes an extended coupler 1225 with fingertip 1226 disposed thereon for gripping with a reciprocating rotational motion. In some embodiments, the lengths thereof are design variables for the optimization problem. Alternatively, or additionally, in some embodiments, worm radius and gear radius of worm-gear 1210 are design variables for the optimization problem. In an example embodiment, the cross-sections of bars 1221, 1222, 1223, and 1224 are considered constant, bars 1221, 1222, 1223, and 1224 are composed of a specified material, and a specific rotational speed and torque are assumed for motor 1230.

In some embodiments, the optimization objective can be, for example, to minimize the time to grasp the object given certain constraints, to minimize a weight of mechanical system 1200, and/or to maximize lifting capacity of mechanical system 1200, among others. Because mechanical system 1200 is broken down via a modular approach into multiple MBBs, equations can be added for a specific module, to define optimization objectives, and/or to apply various constraints on the problem. An example of such a constraint includes a range within with the length of each of bars 1221, 1222, 1223, and 1224 can vary (e.g., +20% to −20% of some initial value) and/or a maximum weight of mechanical system 1200. Equations can be employed that define force at fingertip 1226, distance traveled by fingertip 1226 in the x-direction (for example as a function of the length and angle of certain bars of four-bar linkage 1220), distance traveled by fingertip 1226 in the y-direction (for example as a function of the length and angle of certain bars of four-bar linkage 1220), weight of each four-bar linkage 1220, and the objective function of the study.

### Generation of an Optimized Mechanical System

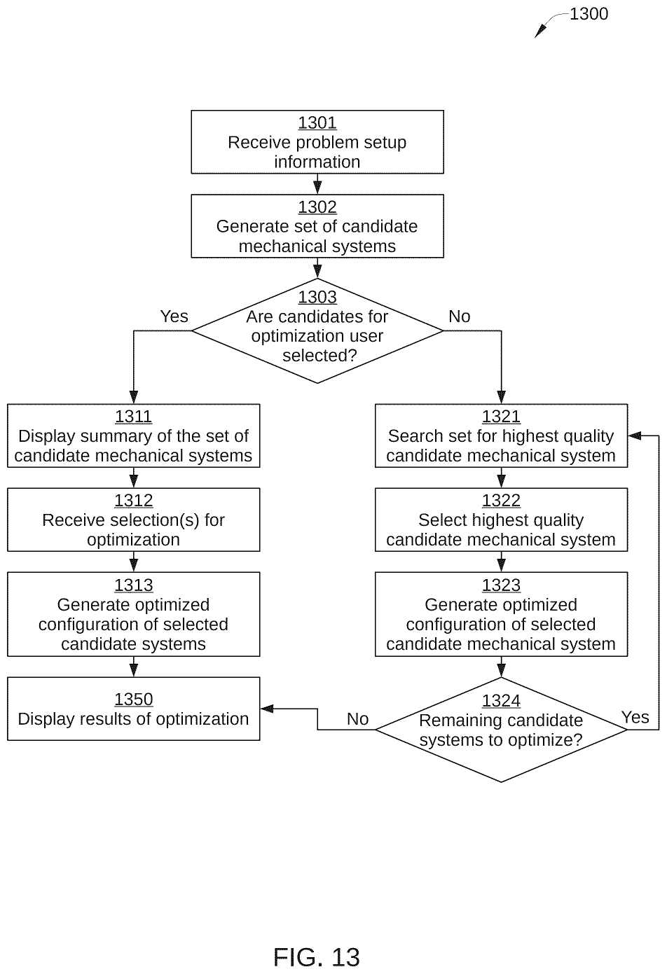

FIG. 13 sets forth a flowchart of method steps for generating an optimized configuration of a mechanical system for solving a mechanical problem, according to various embodiments. Although the method steps are described in conjunction with the system of FIGS. 1-12, persons skilled in the art will understand that any suitable system configured to perform the method steps, in any order, is within the scope of the embodiments.

A computer-implemented method 1300 begins at step 1301, where mechanical system generator 100 receives setup information for a particular mechanical problem, for example, via user-provided inputs 112 to UI 110. In some embodiments, the problem setup information includes mechanical input 901, target mechanical output 902, and values indicating certain design constraints for the mechanical system to be generated by mechanical system generator 100.

In step 1302, mechanical system generator 100 generates a set of candidate mechanical systems based on the problem setup information received in step 1301 and on available MBBs referenced in MBB library 130, for example via candidate mechanical system generator 120. In some embodiments, the set of candidate mechanical systems generated in step 1302 includes all possible permutations of MBBs available in MBB library 130 that can generate target mechanical output 902 when receiving mechanical input 901. In other embodiments, the set of candidate mechanical systems generated in step 1302 includes a subset of all possible permutations of MBBs available in MBB library 130. For example, in some embodiments, candidate mechanical system generator 120 generates candidate mechanical systems for a fixed time interval, generates a fixed number of candidate mechanical systems, or generates candidate mechanical systems that include no more than a threshold number of MBBs.

In step 1303, mechanical system generator 100 determines whether the candidate mechanical systems that are optimized are automatically determined, for example via assembly search engine 150, or are user selected. In some embodiments, mechanical system generator 100 makes such a determination based on an input 112 prior to computer-implemented method 1300. When the candidate mechanical systems to be optimized are user selected, computer-implemented method 1300 proceeds to step 1311; when the candidate mechanical systems to be optimized are automatically selected by mechanical system generator 100, computer-implemented method 1300 proceeds to step 1321.

In step 1311, UI 110 displays a summary of the set of candidate mechanical systems determined in step 1302. For example, in some embodiments, the set of candidate mechanical systems is represented by a constraint graph consistent with constraint graph 900. In step 1312, mechanical system generator 100 receives one or more selections for optimization. For example, in some embodiments, a user provides an input 112 indicating one or more of the candidate mechanical systems included in the set of candidate mechanical systems that are to be optimized by mechanical system generator 100. In some embodiments, at least one of the selections corresponds to a particular kinematic path (candidate mechanical system) indicated in the constraint graph displayed in step 1302. In some embodiments, at least one of the selections corresponds to a subset of the kinematic paths indicated in the constraint graph displayed in step 1302. For example, in such embodiments, at least one of the selections can reference all kinematic paths (candidate mechanical systems) that include a certain MBB or set of MBBs included in the constraint graph. Thus, in such embodiments, the selections received in step 1312 reference a family of related candidate mechanical systems that share one or more MBBs in the constraint graph.

In step 1313, mechanical system generator 100 generates an optimized configuration for each candidate mechanical system selected in step 1312, for example via mechanical system optimization engine 140. In some embodiments, mechanical system optimization engine 140 generates each optimized configuration using a computer-implemented method consistent with computer-implemented method 1100. Computer-implemented method 1300 then proceeds to step 1350.

In step 1321, mechanical system generator 100 searches the set of candidate mechanical systems generated in step 1302 for the highest quality candidate mechanical system, for example via assembly search engine 150. In some embodiments, assembly search engine 150 determines the highest quality candidate mechanical system based on a quality score for each candidate mechanical system in the set of candidate mechanical systems, where the quality score quantifies predicted performance of the candidate mechanical system with respect to an objective function. In such embodiments, the quality score for each candidate mechanical system can be based on one or more criteria, such as the total number of MBBs included in each candidate mechanical system and/or the inclusion of certain types MBBs or combinations of MBBs in each candidate mechanical system. In step 1322, mechanical system generator 100 selects the highest quality (for example having the highest quality score) candidate mechanical system, for example via assembly search engine 150.

In step 1323, mechanical system generator 100 generates an optimized configuration for the candidate mechanical system selected in step 1322, for example via mechanical system optimization engine 140. In some embodiments, mechanical system optimization engine 140 generates the optimized configuration using a computer-implemented method consistent with computer-implemented method 1100. Computer-implemented method 1300 then proceeds to step 1324.

In step 1324, mechanical system generator 100 determines whether there are any remaining candidate mechanical systems to be optimized. If yes, computer-implemented method 1300 returns to step 1321; if no, computer-implemented method 1300 proceeds to step 1350. In some embodiments, all candidate mechanical systems in the set are optimized. In other embodiments, a subset of the highest quality candidate mechanical systems are optimized, such as the five or ten highest scoring candidate mechanical systems in the set. In step 1350, mechanical system generator 100 displays the optimized configuration of each candidate mechanical system that is optimized in computer-implemented method 1300.

### Exemplary Computing Device

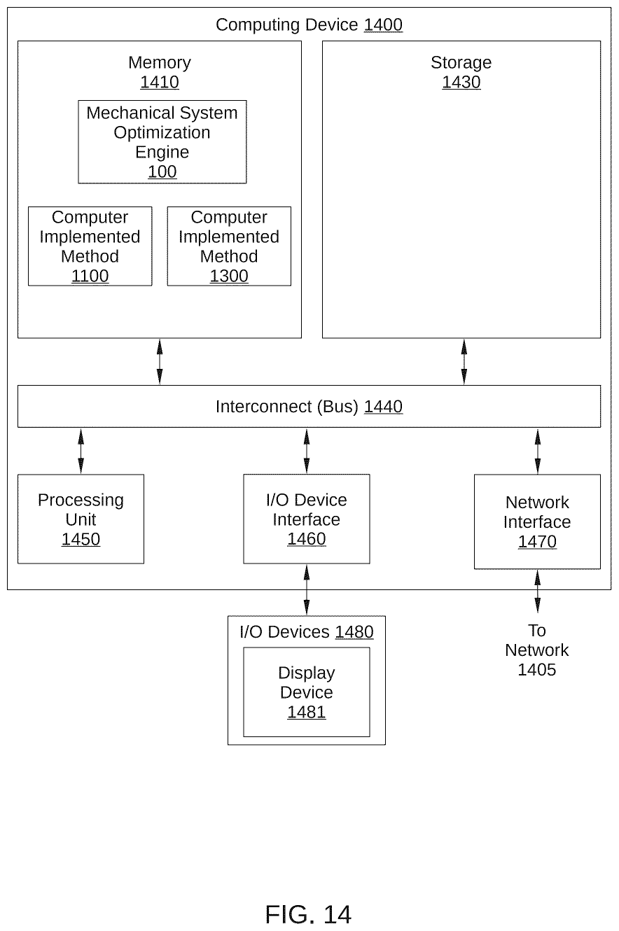

FIG. 14 is a block diagram of a computing device 1400 configured to implement one or more aspects of the various embodiments. Thus, computing device 1400 can be a computing device associated with mechanical system generator 100. Computing device 1400 may be a desktop computer, a laptop computer, a tablet computer, or any other type of computing device configured to receive input, process data, generate control signals, and display images. Computing device 1400 is configured to perform operations associated with mechanical system generator 100, computer-implemented method 1100, computer-implemented method 1300, and/or other suitable software applications, which can reside in a memory 1410. It is noted that the computing device described herein is illustrative and that any other technically feasible configurations fall within the scope of the present disclosure.

As shown, computing device 1400 includes, without limitation, an interconnect (bus) 1440 that connects a processing unit 1450, an input/output (I/O) device interface 1460 coupled to input/output (I/O) devices 1480, memory 1410, a storage 1430, and a network interface 1470. Processing unit 1450 may be any suitable processor implemented as a central processing unit (CPU), a graphics processing unit (GPU), an application-specific integrated circuit (ASIC), a field programmable gate array (FPGA), any other type of processing unit, or a combination of different processing units, such as a CPU configured to operate in conjunction with a GPU. In general, processing unit 1450 may be any technically feasible hardware unit capable of processing data and/or executing software applications, including processes associated with mechanical system generator 100, computer-implemented method 1100, and/or computer-implemented method 1300. Further, in the context of this disclosure, the computing elements shown in computing device 1400 may correspond to a physical computing system (e.g., a system in a data center) or may be a virtual computing instance executing within a computing cloud.

I/O devices 1480 may include devices capable of providing input, such as a keyboard, a mouse, a touch-sensitive screen, and so forth, as well as devices capable of providing output, such as a display device 1481. Additionally, I/O devices 1480 may include devices capable of both receiving input and providing output, such as a touchscreen, a universal serial bus (USB) port, and so forth. I/O devices 1480 may be configured to receive various types of input from an end-user of computing device 1400, and to also provide various types of output to the end-user of computing device 1400, such as one or more graphical user interfaces (GUI), displayed digital images, and/or digital videos. In some embodiments, one or more of I/O devices 1480 are configured to couple computing device 1400 to a network 1405.

Memory 1410 may include a random access memory (RAM) module, a flash memory unit, or any other type of memory unit or combination thereof. Processing unit 1450, I/O device interface 1460, and network interface 1470 are configured to read data from and write data to memory 1410. Memory 1410 includes various software programs that can be executed by processor 1450 and application data associated with said software programs, including mechanical system generator 100, computer-implemented method 1100, and/or computer-implemented method 1300.

In sum, the various embodiments described herein provide techniques for generating one or more optimized mechanical systems for solving a particular mechanical problem. Specifically, given a mechanical input, a target mechanical output, and one or more design objectives, the techniques can generate an optimized mechanical system that solves the mechanical problem by generating the target mechanical output. The mechanical system is assembled from kinematically compatible modular units (MBBs), and parametric optimization is performed on the modular units to generate an optimized configuration of the mechanical system. The MBBs can correspond to widely used mechanical devices employed in industry for assembling mechanical systems. In the embodiments, a library of MBBs can be assembled to form different mechanical systems, and dynamic equations associated with each MBB of the mechanical system are used to construct a system matrix that enables parametric optimization of the mechanical system.

At least one technical advantage of the disclosed techniques relative to the prior art is that the disclosed techniques enable the automated generation of a multi-device mechanical system that has a quantified performance with respect to one or more design objectives. As a result, for a given mechanical problem, a mechanical system of multiple kinematically linked mechanical devices can be generated that has a desired effectiveness relative to other potential solutions to the mechanical problem. A further technical advantage of the disclosed techniques is that time-consuming and complex engineering tasks can be expedited and/or automated, such as selecting, modifying, and designing mechanical assemblies. These technical advantages provide one or more technological advancements over prior art approaches.

1. In some embodiments, a computer-implemented method for generating a mechanical system includes: based on a mechanical input to the mechanical system and a target mechanical output of the mechanical system, generating a set of multiple candidate mechanical systems for generating the target mechanical output in response to receiving the mechanical input, wherein each candidate mechanical system includes multiple mechanical building blocks that form a kinematic chain; selecting a candidate mechanical system included in the set of multiple candidate mechanical systems; and generating an optimized configuration of the selected candidate mechanical system based on a set of dynamic equations for the mechanical system, wherein each dynamic equation included in the set of dynamic equations corresponds to one mechanical building block of the selected candidate mechanical system.

2. The computer-implemented method of clause 1, wherein determining the optimized configuration of the mechanical system comprises determining a set of parametric values for the set of dynamic equations via parametric optimization, wherein the set of parametric values is associated with the optimized configuration of the mechanical system.

3. The computer-implemented method of clauses 1 or 2, wherein generating the set of multiple candidate mechanical systems comprises determining a mechanical building block that receives the mechanical input to the mechanical system.

4. The computer-implemented method of any of clauses 1-3, wherein determining the mechanical building block comprises selecting the mechanical building block from a library of mechanical building blocks and associated dynamic equations.

5. The computer-implemented method of any of clauses 1-4, wherein generating the set of multiple candidate mechanical systems comprises determining a mechanical building block that generates the target mechanical output.

6. The computer-implemented method of any of clauses 1-5, further comprising receiving a user input indicating the candidate mechanical system included in the set of multiple candidate mechanical systems, wherein the selected candidate mechanical system is selected based on the user input.

7. The computer-implemented method of any of clauses 1-6, further comprising determining, for each candidate mechanical system included in the set of multiple candidate mechanical systems, a performance score, wherein the selected candidate mechanical system is selected based on the performance score of the selected candidate mechanical system.

8. The computer-implemented method of any of clauses 1-7, wherein the performance score quantifies a performance of the corresponding candidate mechanical system with respect to an objective function.

9. The computer-implemented method of any of clauses 1-8, wherein the optimized configuration of the mechanical system is further based on one or more design objectives associated with the mechanical system.

10. The computer-implemented method of any of clauses 1-9, wherein each design objective included in the one or more design objectives corresponds to one of a target value for a physical attribute of the mechanical system or a target value for a mechanical output of a mechanical building block included in the selected candidate mechanical system.

11. The computer-implemented method of any of clauses 1-10, wherein the optimized configuration of the mechanical system is further based on one or more design constraints associated with the mechanical system.

12. The computer-implemented method of any of clauses 1-11, wherein each of the one or more design constraints corresponds to one of a maximum value for a physical attribute of the mechanical system or a minimum value for the physical attribute of the mechanical system.

13. The computer-implemented method of any of clauses 1-12, wherein selecting the candidate mechanical system included in the set of multiple candidate mechanical systems comprises: generating a constraint graph that includes the set of multiple candidate mechanical systems; and receiving an input associated with the constraint graph that indicates the candidate mechanical system included in the set of multiple candidate mechanical systems.

14. In some embodiments, a non-transitory computer readable medium includes a set of instructions which, in response to execution by a processor of a computer system, cause the processor to perform the steps of: based on a mechanical input to a mechanical system and a target mechanical output of the mechanical system, generating a set of multiple candidate mechanical systems for generating the target mechanical output in response to receiving the mechanical input, wherein each candidate mechanical system includes multiple mechanical building blocks that form a kinematic chain; selecting a candidate mechanical system included in the set of multiple candidate mechanical systems; and generating an optimized configuration of the selected candidate mechanical system based on a set of dynamic equations for the mechanical system, wherein each dynamic equation included in the set of dynamic equations corresponds to one mechanical building block of the selected candidate mechanical system.

15. The non-transitory computer readable medium of clause 14, wherein determining the optimized configuration of the mechanical system comprises determining a set of parametric values for the set of dynamic equations via parametric optimization, wherein the set of parametric values is associated with the optimized configuration of the mechanical system.

16. The non-transitory computer readable medium of clauses 14 or 15, wherein generating the set of multiple candidate mechanical systems comprises determining a mechanical building block that receives the mechanical input to the mechanical system.

17. The non-transitory computer readable medium of any of clauses 1-16, wherein determining the mechanical building block comprises selecting the mechanical building block from a library of mechanical building blocks and associated dynamic equations.

18. The non-transitory computer readable medium of any of clauses 1-17, wherein generating the set of multiple candidate mechanical systems comprises determining a mechanical building block that generates the target mechanical output.

19. The non-transitory computer readable medium of any of clauses 1-18, wherein the optimized configuration of the mechanical system is further based on one or more design objectives associated with the mechanical system.

20. In some embodiments, a system includes: a memory that stores instructions; and a processor that is communicatively coupled to the memory and is configured to, when executing the instructions, perform the steps of: based on a mechanical input to a mechanical system and a target mechanical output of the mechanical system, generating a set of multiple candidate mechanical systems for generating the target mechanical output in response to receiving the mechanical input, wherein each candidate mechanical system includes multiple mechanical building blocks that form a kinematic chain; selecting a candidate mechanical system included in the set of multiple candidate mechanical systems; and generating an optimized configuration of the selected candidate mechanical system based on a set of dynamic equations for the mechanical system, wherein each dynamic equation included in the set of dynamic equations corresponds to one mechanical building block of the selected candidate mechanical system.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating a mechanical system, the method comprising:
based on a mechanical input to the mechanical system and a target mechanical output of the mechanical system, generating a set of multiple candidate mechanical systems for generating the target mechanical output in response to receiving the mechanical input, wherein each candidate mechanical system includes multiple mechanical building blocks that form a kinematic chain;
selecting a candidate mechanical system included in the set of multiple candidate mechanical systems; and
generating an optimized configuration of the selected candidate mechanical system based on a set of dynamic equations for the mechanical system, wherein each dynamic equation included in the set of dynamic equations corresponds to one mechanical building block of the selected candidate mechanical system.

2. The computer-implemented method of claim 1, wherein determining the optimized configuration of the mechanical system comprises determining a set of parametric values for the set of dynamic equations via parametric optimization, wherein the set of parametric values is associated with the optimized configuration of the mechanical system.

3. The computer-implemented method of claim 1, wherein generating the set of multiple candidate mechanical systems comprises determining a mechanical building block that receives the mechanical input to the mechanical system.

4. The computer-implemented method of claim 3, wherein determining the mechanical building block comprises selecting the mechanical building block from a library of mechanical building blocks and associated dynamic equations.

5. The computer-implemented method of claim 1, wherein generating the set of multiple candidate mechanical systems comprises determining a mechanical building block that generates the target mechanical output.

6. The computer-implemented method of claim 1, further comprising receiving a user input indicating the candidate mechanical system included in the set of multiple candidate mechanical systems, wherein the selected candidate mechanical system is selected based on the user input.

7. The computer-implemented method of claim 1, further comprising determining, for each candidate mechanical system included in the set of multiple candidate mechanical systems, a performance score, wherein the selected candidate mechanical system is selected based on the performance score of the selected candidate mechanical system.

8. The computer-implemented method of claim 7, wherein the performance score quantifies a performance of the corresponding candidate mechanical system with respect to an objective function.

9. The computer-implemented method of claim 1, wherein the optimized configuration of the mechanical system is further based on one or more design objectives associated with the mechanical system.

10. The computer-implemented method of claim 9, wherein each design objective included in the one or more design objectives corresponds to one of a target value for a physical attribute of the mechanical system or a target value for a mechanical output of a mechanical building block included in the selected candidate mechanical system.

11. The computer-implemented method of claim 1, wherein the optimized configuration of the mechanical system is further based on one or more design constraints associated with the mechanical system.

12. The computer-implemented method of claim 11, wherein each of the one or more design constraints corresponds to one of a maximum value for a physical attribute of the mechanical system or a minimum value for the physical attribute of the mechanical system.

13. The computer-implemented method of claim 1, wherein selecting the candidate mechanical system included in the set of multiple candidate mechanical systems comprises:
generating a constraint graph that includes the set of multiple candidate mechanical systems; and
receiving an input associated with the constraint graph that indicates the candidate mechanical system included in the set of multiple candidate mechanical systems.

14. A non-transitory computer readable medium that includes a set of instructions which, in response to execution by a processor of a computer system, cause the processor to perform the steps of:
based on a mechanical input to a mechanical system and a target mechanical output of the mechanical system, generating a set of multiple candidate mechanical systems for generating the target mechanical output in response to receiving the mechanical input, wherein each candidate mechanical system includes multiple mechanical building blocks that form a kinematic chain;
selecting a candidate mechanical system included in the set of multiple candidate mechanical systems; and
generating an optimized configuration of the selected candidate mechanical system based on a set of dynamic equations for the mechanical system, wherein each dynamic equation included in the set of dynamic equations corresponds to one mechanical building block of the selected candidate mechanical system.

15. The non-transitory computer readable medium of claim 14, wherein determining the optimized configuration of the mechanical system comprises determining a set of parametric values for the set of dynamic equations via parametric optimization, wherein the set of parametric values is associated with the optimized configuration of the mechanical system.

16. The non-transitory computer readable medium of claim 14, wherein generating the set of multiple candidate mechanical systems comprises determining a mechanical building block that receives the mechanical input to the mechanical system.

17. The non-transitory computer readable medium of claim 16, wherein determining the mechanical building block comprises selecting the mechanical building block from a library of mechanical building blocks and associated dynamic equations.

18. The non-transitory computer readable medium of claim 14, wherein generating the set of multiple candidate mechanical systems comprises determining a mechanical building block that generates the target mechanical output.

19. The non-transitory computer readable medium of claim 14, wherein the optimized configuration of the mechanical system is further based on one or more design objectives associated with the mechanical system.

20. A system, comprising:
a memory that stores instructions; and
a processor that is communicatively coupled to the memory and is configured to, when executing the instructions, perform the steps of:
based on a mechanical input to a mechanical system and a target mechanical output of the mechanical system, generating a set of multiple candidate mechanical systems for generating the target mechanical output in response to receiving the mechanical input, wherein each candidate mechanical system includes multiple mechanical building blocks that form a kinematic chain;
selecting a candidate mechanical system included in the set of multiple candidate mechanical systems; and
generating an optimized configuration of the selected candidate mechanical system based on a set of dynamic equations for the mechanical system, wherein each dynamic equation included in the set of dynamic equations corresponds to one mechanical building block of the selected candidate mechanical system.
